(19) United States
(12) Patent Application Publication
(10) Pub. No.: US 2009/0279010 A1
(43) Pub. Date: Nov. 12, 2009

(54) LIQUID CRYSTAL DISPLAY

(76) Inventor: Dong-Gyu KIM, Yongin-si (KR)

Correspondence Address: Haynes and Boone, LLP;IP Section, 2323 Victory Avenue, SUITE 700, Dallas, TX, 75219, US

(21) Appl. No.: 12/212,540

(22) Filed: Sep. 17, 2008

(30) Foreign Application Priority Data
May 6, 2008 (KR) 10-2008-0041797

(51) Int. Cl. G02F 1/136

(52) U.S. Cl. 349/46

(57) ABSTRACT

Embodiments of the present invention relate to a liquid crystal display. A liquid crystal display according to an exemplary embodiment of the present invention includes a first substrate and a second substrate, a plurality of pixel electrodes formed on the first substrate and arranged in a matrix, a common electrode facing the pixel electrodes, and a liquid crystal layer interposed between the first substrate and the second substrate and including a plurality of liquid crystal molecules, wherein the liquid crystal layer includes a plurality of domains having different alignment directions of the liquid crystal molecules, and areas of effective display regions where the alignment directions of the liquid crystal molecules are uniform in the respective domains are the same as each other among the plurality of domains.

### CROSS-REFERENCE TO RELATED APPLICATION

This application claims priority to and the benefit of Korean Patent Application No. 10-2008-0041797 filed in the Korean Intellectual Property Office on May 6, 2008, the entire contents of which are incorporated herein by reference.

### BACKGROUND

(a) Technical Field

Embodiments of the present invention relate to a liquid crystal display.

(b) Description of the Related Art

A liquid crystal display (LCD) is one of the most commonly used flat panel displays, and it includes two substrates with field generating electrodes formed thereon and a liquid crystal (LC) layer interposed between the two substrates. In the LCD, voltages are applied to the field generating electrodes to generate an electric field in the LC layer and realign liquid crystal molecules in the LC layer, thereby regulating the polarization and transmittance of incident light passing through the LC layer and displaying images.

Among the LCDs, a vertical alignment (VA) mode LCD, which aligns LC molecules such that their long axes are perpendicular to the panels in the absence of an electric field, is spotlighted because of its high contrast ratio and wide reference viewing angle.

In the vertical alignment (VA) mode LCD, the wide reference viewing angle may be realized by forming a plurality of domains in which the alignment directions of LC molecules are different from each other in one pixel.

To form the plurality of domains in one pixel, cutouts such as minute slits may be formed in the field generating electrodes, or protrusions may be formed on the field generating electrodes. In this way, the plurality of domains may be formed by aligning the LC molecules vertically to a fringe field generated between the edges of the cutouts or the protrusions and the field generating electrode facing the edges.

Among the LCDs, in a planar alignment mode LCD, in which the long axes of the LC molecules are parallel to the panels in the absence of an electric field, an electric field parallel to the panels determines the alignment direction of the LC molecules. In detail, a common electrode and pixel electrodes are all formed in the substrate including thin film transistors, and a planar electric field (i.e., an electric field parallel to the display panel) determines the alignment direction of the LC molecules such that the transmittance of light passing through the LC layer is regulated, thereby displaying images. For example, there is an in-plane switching (IPS) mode LCD, or a fringe field switching (FFS) mode LCD. In such a planar alignment mode LCD, the alignment direction of the LC molecules doesn't include a component vertical to the substrate so that changes of the luminance and color according to the viewing angle are small, thereby realizing a wide viewing angle.

Further, the LCD includes a plurality of pixels arranged in a matrix, and each pixel includes a pixel electrode and a switching element for applying a voltage to each pixel electrode. Each switching element is connected to a gate line and a data line, and the pixel electrode is connected to the switching element and supplied with a data voltage from the data line. In order to prevent deterioration of the display quality due to application of an electric field having unvarying direction during a long time, the polarity of a data signal with respect to the common voltage may be reversed between two adjacent data lines.

The above information disclosed in this Background section is only for enhancement of understanding of the background of this disclosure and therefore it may contain information that does not form the prior art that is already known in this country to a person of ordinary skill in the art.

### SUMMARY

A liquid crystal display according to an exemplary embodiment of the present invention includes a first substrate and a second substrate, a plurality of pixel electrodes formed on the first substrate and arranged in a matrix, a common electrode facing the pixel electrodes, and a liquid crystal layer interposed between the first substrate and the second substrate and including a plurality of liquid crystal molecules, wherein the liquid crystal layer includes a plurality of domains having different alignment directions of the liquid crystal molecules, and areas of an effective display region where the alignment direction of the liquid crystal molecules is uniform in each domain are the same with each other among the plurality of domains.

The liquid crystal display may further include a plurality of gate lines formed on the first substrate, a plurality of data lines intersecting the gate lines and transmitting data signals, and a plurality of switching elements each including a gate electrode connected to a respective gate line, a source electrode connected to a respective data line, and a drain electrode connected to a respective pixel electrode.

The switching element may be disposed in a region overlapping a lower portion of the pixel electrode and close to the data line.

The drain electrode may include an expansion portion contacting a portion of the pixel electrode and transmitting data signals, a bar portion facing the source electrode, and a transverse portion connecting the bar portion and the expansion portion in a horizontal direction, wherein the expansion portion is disposed in a region overlapping a lower portion of the pixel electrode and beside the switching element.

A width of the gate line disposed below the expansion portion of the drain electrode may be narrower than the other portion of the gate line.

A portion of the transverse portion of the drain electrode may overlap a lower end portion of the pixel electrode.

The transverse portion of the drain electrode may be formed in the transverse direction following a lower edge of the pixel electrode.

A length of the transverse portion of the drain electrode may be more than half of a length of the lower edge of the pixel electrode.

A width of the transverse portion of the drain electrode is less than a cell gap of the liquid crystal layer.

Polarities of the data signals applied to two neighboring pixel electrodes in a row direction or a column direction may be opposite to each other.

Polarities of the data signals applied to two neighboring data lines may be opposite to each other.

One data line may be disposed between two neighboring columns of the pixel electrodes, and two neighboring switching elements in a row direction or a column direction may be connected to different data lines that are adjacent to each other.

Two data lines may be disposed between neighboring columns of the pixel electrodes, two neighboring switching elements in a column direction may be connected to different data lines that are adjacent to each other, and two neighboring switching elements in a row direction may be connected to different data lines that are not adjacent to each other.

A pair of gate lines connected to the pixel electrodes of two neighboring rows may transmit the same gate signal.

The common electrode may be formed on the second substrate.

The liquid crystal display may further include an inclination direction determination member formed in the pixel electrode, or the common electrode may be included.

The inclination direction determination member may include cutouts or protrusions.

The pixel electrode may include a plurality of minute branches, and the pixel electrode may include a plurality of subregions having different length directions of the minute branches.

The common electrode may be formed on the first substrate. The pixel electrode and the common electrode may be formed in the same layer, the common electrode may include a plurality of branches and a longitudinal portion connecting the branches to each other, the pixel electrode may include a plurality of pixel branches and a longitudinal pixel portion connecting the pixel branches to each other, the branches and the pixel branches may be inclined forming an oblique angle with the gate lines, and the branches and the pixel branches may be alternately disposed.

The common electrode may be formed under the pixel electrode, and the pixel electrode may include a plurality of pixel branches.

The pixel branches may be inclined forming an oblique angle with the gate lines.

A liquid crystal display according to another exemplary embodiment of the present invention includes a first substrate and a second substrate, a gate line formed on the first substrate, a data line intersecting the gate line and transmitting a data signal, a switching element including a gate electrode connected to the gate line, a source electrode connected to the data line and a drain electrode, a pixel electrode including a contact portion overlapping and connected to an end portion of the drain electrode, and an effective display unit, and a liquid crystal layer interposed between the first substrate and the second substrate and including a plurality of liquid crystal molecules, wherein the effective display unit of the pixel electrode includes a plurality of sub-regions, and alignment directions of the liquid crystal molecules disposed above the plurality of sub-regions are different from each other, and the switching element and the contact portion are disposed outside the effective display unit.

### BRIEF DESCRIPTION OF THE DRAWINGS

FIG. 1 is a block diagram of a liquid crystal display according to an exemplary embodiment of the present invention.

FIG. 2 is an equivalent circuit diagram of one pixel in a liquid crystal display according to an exemplary embodiment of the present invention.

FIG. 3 is a layout view of a liquid crystal display according to an exemplary embodiment of the present invention.

FIG. 4 is a top plan view of a pixel electrode of the liquid crystal display shown in FIG. 3.

FIG. 5 is a cross-sectional view of the liquid crystal display shown in FIG. 3 taken along the line V-V.

FIG. 6 and FIG. 7 are views showing the arrangement of pixels and polarities of the data voltages and the pixel voltages of a liquid crystal display according to an exemplary embodiment of the present invention.

FIG. 8 is a layout view of a liquid crystal display according to another exemplary embodiment of the present invention.

FIG. 9 is a top plan view of a pixel electrode in the liquid crystal display shown in FIG. 8.

FIG. 10 is a layout view of a liquid crystal display according to another exemplary embodiment of the present invention.

FIG. 11 is a cross-sectional view of the liquid crystal display shown in FIG. 10 taken along the line XI-XI.

FIG. 12 is an equivalent circuit diagram of one pixel in a liquid crystal display according to another exemplary embodiment of the present invention.

FIG. 13 is a layout view of a liquid crystal display according to another exemplary embodiment of the present invention.

FIG. 14 is a cross-sectional view of the liquid crystal display shown in FIG. 13 taken along the line XIV-XIV.

FIG. 15 is an equivalent circuit diagram of one pixel in a liquid crystal display according to another exemplary embodiment of the present invention.

FIG. 16 is a layout view of a liquid crystal display according to another exemplary embodiment of the present invention.

FIG. 17 is a cross-sectional view of the liquid crystal display shown in FIG. 16 taken along the line XVII-XVII.

### DETAILED DESCRIPTION

Embodiments of the present invention will be described more fully hereinafter with reference to the accompanying drawings, in which exemplary embodiments of the invention are shown. As those skilled in the art would realize, the described embodiments may be modified in various different ways, all without departing from the spirit or scope of the present disclosure.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element, or intervening elements may also be present. In contrast, when an element is referred to as being “directly on” another element, there are no intervening elements present.

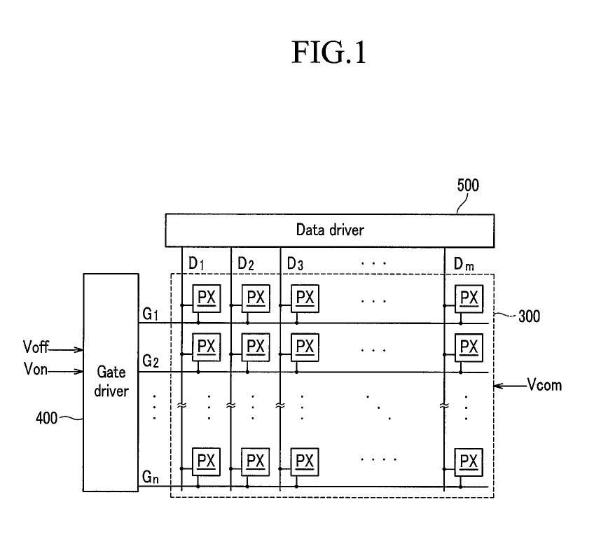

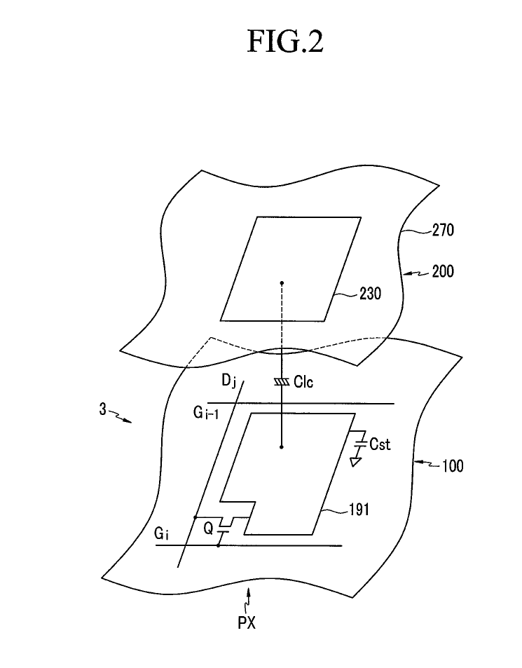

Now, a liquid crystal display according to an exemplary embodiment of the present invention will be described with reference to FIG. 1 and FIG. 2.

FIG. 1 is a block diagram of a liquid crystal display according to an exemplary embodiment of the present invention, and FIG. 2 is an equivalent circuit diagram of one pixel in the liquid crystal display according to an exemplary embodiment of the present invention.

As shown in FIG. 1, a liquid crystal display according to an exemplary embodiment of the present invention includes a liquid crystal panel assembly 300, a gate driver 400, and a data driver 500.

In view of an equivalent circuit, the liquid crystal panel assembly 300 includes a plurality of signal lines G₁-Gₙ and D₁-Dₘ, and a plurality of pixels PX that are connected to the signal lines and are arranged in a matrix. Meanwhile, referring to the embodiment shown in FIG. 2, the liquid crystal panel assembly 300 includes lower and upper display panels 100 and 200 that face each other, and a liquid crystal layer 3 interposed therebetween.

The signal lines G₁-Gₙ and D₁-Dₘ are provided on the lower panel 100, and include a plurality of gate lines G₁-Gₙ that transmit gate signals (also referred to as “scanning signals”), and a plurality of data lines D₁-Dₘ that transmit data signals. The gate lines G₁-Gₙ substantially extend in a row direction and are parallel to each other, and the data lines D₁-Dₘ extend in a substantially column direction and are parallel to each other.

Each pixel PX, for example a pixel PX that is connected to the i-th (i=1, 2, . . . , n) gate line Gᵢ and the j-th (j=1, 2, . . . , m) data line Dⱼ, includes a switching element Q that is connected to the signal lines Gᵢ and Dⱼ, and a liquid crystal capacitor Clc and a storage capacitor Cst that are connected thereto. The storage capacitor Cst may be omitted if necessary.

The switching element Q is a three terminal element such as a thin film transistor and is provided on the lower panel 100, and a control terminal thereof is connected to the gate line Gᵢ, an input terminal thereof is connected to the data line Dⱼ, and an output terminal thereof is connected to the liquid crystal capacitor Clc and the storage capacitor Cst.

The liquid crystal capacitor Clc has two terminals, on a pixel electrode 191 of the lower panel 100 and on a common electrode 270 of the upper panel 200. The liquid crystal layer 3 between the two electrodes 191 and 270 serves as a dielectric material.

The storage capacitor Cst functions as an auxiliary capacitor for the LC capacitor Clc. The storage capacitor Cst includes the pixel electrode 191 and a separately-provided signal line (not shown) on the lower panel 100 overlapping the pixel electrode 191 via an insulator. The separate signal line is supplied with a predetermined voltage such as a common voltage Vcom. Alternatively, the storage capacitor Cst may include the pixel electrode 191 and a previous gate line Gᵢ₋₁ overlapping the pixel electrode 191 via an insulator.

For color display, each pixel PX may uniquely represent one of three primary colors (i.e., spatial division) or each pixel PX may sequentially represent the three primary colors in turn (i.e., temporal division), such that a spatial or temporal sum of the primary colors is recognized as a desired color. An example of a set of the three primary colors includes red, green, and blue colors. FIG. 2 shows an example of the spatial division in which each pixel PX includes a color filter 230 representing one of the primary colors in an area of the upper panel 200 facing the pixel electrode 191. Alternatively, the color filter 230 may be provided on or under the pixel electrode 191 on the lower panel 100.

At least one polarizer (not shown) may be attached on the outer side of the liquid crystal panel assembly 300.

Referring again to FIG. 1, the data driver 500 is connected to the data lines D₁-Dₘ of the liquid crystal panel assembly 300, and applies data voltages to the data lines D₁-Dₘ.

The gate driver 400 is connected to the gate lines G₁ to Gₙ of the liquid crystal panel assembly 300, and applies gate signals obtained which are a combination of a gate-on voltage Von and a gate-off voltage Voff to the gate lines G₁ to Gₙ.

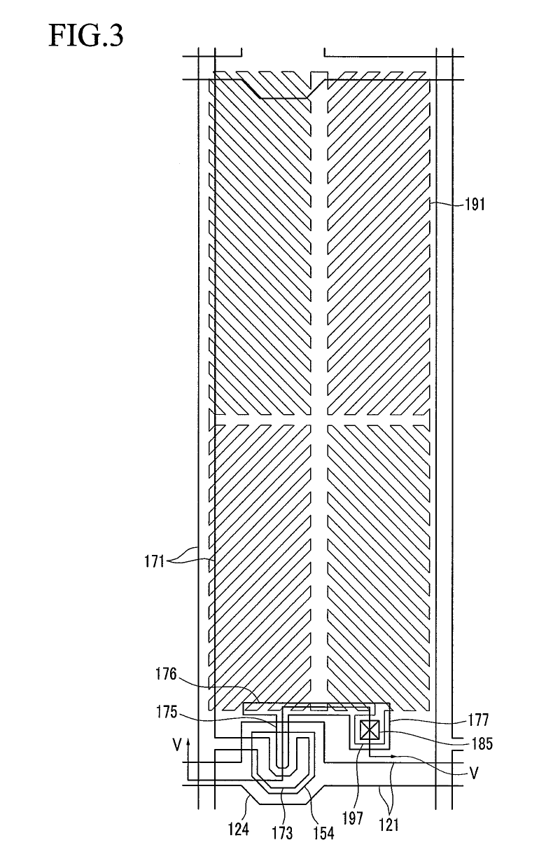

Next, one example of the liquid crystal display shown in FIG. 1 and FIG. 2 will be described with reference to FIG. 3 to FIG. 5.

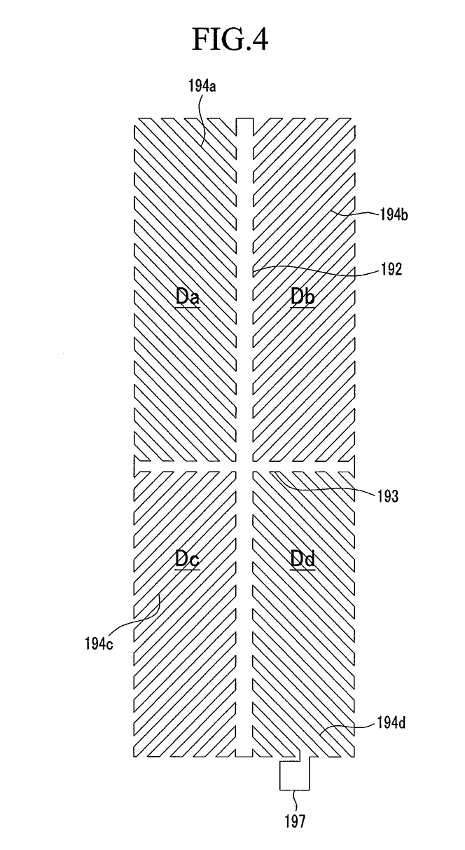

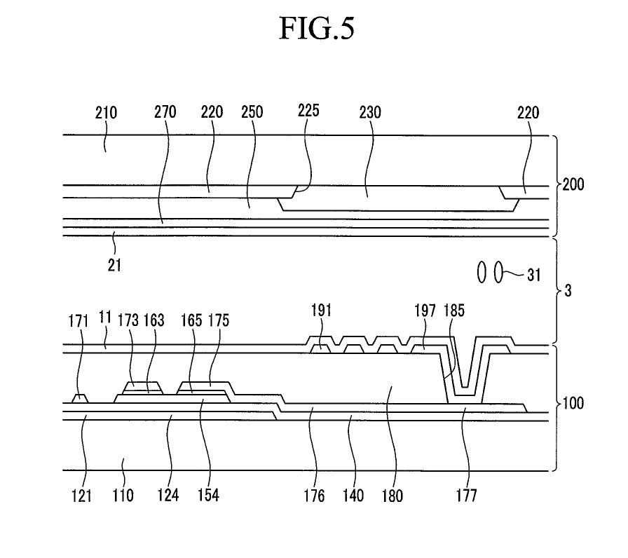

FIG. 3 is a layout view of a liquid crystal display according to an exemplary embodiment of the present invention, FIG. 4 is a top plan view of a pixel electrode of the liquid crystal display shown in FIG. 3, and FIG. 5 is a cross-sectional view of the liquid crystal display shown in FIG. 3 taken along the line V-V.

Referring to FIG. 3 to FIG. 5, a liquid crystal panel assembly according to an exemplary embodiment of the present invention includes a lower panel 100 and an upper panel 200 facing each other, and a liquid crystal layer 3 interposed therebetween.

Now, the lower panel 100 will be described according to one or more embodiments.

A plurality of gate lines 121 respectively including a plurality of gate electrodes 124 protruding upward are formed on an insulating substrate 110. The gate lines 121 transmit gate signals and extend in a transverse direction.

A gate insulating layer 140 is formed on the gate lines 121, and a plurality of semiconductor islands 154 that may be made of hydrogenated amorphous silicon or polysilicon are formed on the gate insulating layer 140.

A plurality of pairs of ohmic contact islands 163 and 165 are formed on the semiconductor islands 154. The ohmic contact islands 163 and 165 may be made of n+hydrogenated amorphous silicon (a—Si) heavily doped with an n-type impurity such as phosphorous, or they may be made of a silicide.

A plurality of data lines 171 and a plurality of drain electrodes 175 are formed on the ohmic contacts 163 and 165 and the gate insulating layer 140.

The data lines 171 transmit data voltages and substantially extend in the longitudinal direction, thereby intersecting the gate lines 121. The data lines 171 include a plurality of source electrodes 173 extending toward the gate electrodes 124 and having a “U” shape.

The drain electrodes 175 include a longitudinal portion 175, a transverse portion 176, and an expansion portion 177. The longitudinal portion 175 is opposite to the source electrode 173 with respect to the gate electrode 124. The transverse portion 176 vertically intersects the longitudinal portion 175 and is parallel to the gate lines 121. The width of the transverse portion 176 of the drain electrode 175 may be less than the cell gap of the liquid crystal layer 3. The expansion portion 177 is disposed on one end of the transverse portion 176 and has a wide area for connection with another layer.

A gate electrode 124, a source electrode 173, and a drain electrode 175 form a thin film transistor (TFT) Q along with a semiconductor island 154, and a channel of the thin film transistor Q is formed in the semiconductor island 154 between the source electrode 173 and the drain electrode 175.

The ohmic contacts 163 and 165 are interposed only between the underlying semiconductor islands 154 and the overlying data lines 171 and the drain electrodes 175 thereon, and reduce contact resistance therebetween. The semiconductor islands 154 include exposed portions that are not covered by the source electrodes 173 and the drain electrodes 175, such as the portions that are disposed between the data lines 171 and the drain electrodes 175.

A passivation layer 180, which may be made of an organic insulating material or an inorganic insulating material, is formed on the data lines 171, the drain electrodes 175 and the exposed semiconductor islands 154.

The passivation layer 180 includes a plurality of contact holes 185 exposing the expansion portions 177 of the drain electrodes 175.

A plurality of pixel electrodes 191 that may be made of a transparent conductive material such as indium tin oxide (ITO) or indium zinc oxide (IZO), or a reflective metal such as aluminum, silver, chromium, or an alloy thereof, are formed on the passivation layer 180.

Referring to FIG. 4, the whole shape of the pixel electrodes 191 may be a quadrangle, and each pixel electrode 191 includes a transverse stem 193, a longitudinal stem 192 intersecting the transverse stem 193, a plurality of first to fourth minute branches 194a, 194b, 194c, and 194d, and a lower protrusion 197. Also, the pixel electrode 191 is divided into a first sub-region Da, a second sub-region Db, a third sub-region Dc, and a fourth sub-region Dd by the transverse stem 193 and the longitudinal stem 192, and each sub-region Da-Dd includes a plurality of first, second, third, and fourth minute branches 194a, 194b, 194c, and 194d. The four sub-regions Da-Dd form together an effective display unit where light is transmitted.

The first minute branch 194a obliquely extends from the transverse stem 193 or the longitudinal stem 192 in the upper-left direction, and the second minute branch 194b obliquely extends from the transverse stem 193 or the longitudinal stem 192 in the upper-right direction. Also, the third minute branch 194c obliquely extends from the transverse stem 193 or the longitudinal stem 192 in the lower-left direction, and the fourth minute branch 194d obliquely extends from the transverse stem 193 or the longitudinal stem 192 in the lower-right direction.

The first to fourth minute branches 194a-194d form an angle of about 45 degrees or 135 degrees with the gate lines 121 or the transverse stem 193. Also, the minute branches 194a-194d of two neighboring sub-regions Da-Dd may form a right angle with each other.

The lower protrusion 197 of the pixel electrode 191 is connected to the drain electrode 175 through the contact hole 185 to receive a data voltage from the drain electrode 175.

An alignment layer 11 is formed on the pixel electrodes 191.

Next, the upper panel 200 will be described according to one or more embodiments.

A light blocking member 220 is formed on a substrate 210. The light blocking member 220 prevents light leakage generated between the pixel electrodes 191, and includes a plurality of openings 225 facing the pixel electrodes 191.

A plurality of color filters 230 are formed on the substrate 210 and the light blocking member 220. Most of the color filters 230 are disposed in the regions enclosed by the light blocking members 220, and may extend according to the column of the pixel electrodes 191. Each color filter 230 may display one color among primary colors such as three primary colors of red, green or blue.

An overcoat 250 is formed on the color filters 230 and the light blocking member 220, and a common electrode 270 that may be made of a transparent conductor such as ITO or IZO is formed substantially on the whole surface of the overcoat 250.

An alignment layer 21 is coated on the common electrode 270. The two alignment layers 11 and 21 may be vertical alignment layers.

Polarizers (not shown) may be provided on the outer surface of the display panels 100 and 200.

The liquid crystal layer 3 between the lower panel 100 and the upper panel 200 may include liquid crystal molecules 31 having negative dielectric anisotropy, and the liquid crystal molecules 31 may be oriented such that the major axes of the liquid crystal molecules 31 are almost perpendicular to the surfaces of the two display panels 100 and 200 when no electric field is applied.

Next, an operation of the liquid crystal display according to an exemplary embodiment of the present invention will be described.

If a gate-on voltage is applied to the gate line 121, the thin film transistor Q connected thereto is turned on. Accordingly, a data voltage applied to the data line 171 is transmitted to the pixel electrode 191 through the thin film transistor Q that is turned on.

The transverse portion 176 of the drain electrode 175 extends in the transverse direction such that any influence applied to the pixel electrode 191 may be prevented when applying a gate-off voltage Voff to the gate line 121. For this purpose, the length of the transverse portion 176 of the drain electrode 175 may be more than half of the length of the lower edge of the pixel electrode 191.

The pixel electrode 191 supplied with the data voltage generates an electric field in the liquid crystal layer 3 along with the common electrode 270 that is supplied with the common voltage Vcom. Thus, the liquid crystal molecules 31 of the liquid crystal layer 3 may change directions so that the major axes thereof become vertical to the direction of the electric field in response to the electric field. The polarization of incident light into the liquid crystal layer 3 is changed according to the inclination degree of the liquid crystal molecules 31, and the change of the polarization appears as a change of the transmittance by the polarizer, thereby displaying images.

The inclination direction of the liquid crystal molecules 31 is determined by the minute branches 194a-194d of the pixel electrodes 191, and the liquid crystal molecules 31 are inclined in the direction parallel to the length direction of the minute branches 194a-194d. In an exemplary embodiment of the present invention, the length directions in which the minute branches 194a-194d are extended in one pixel PX are in all four directions such that the inclination directions of the liquid crystal molecules 31 are in all four directions. Therefore, the viewing angle of the liquid crystal display is widened by varying the inclined directions of the liquid crystal molecules.

Also, as described above, in the present exemplary embodiment, the contact hole 185 in which the expansion 177 of the drain electrode 175 and the protrusion 197 of the pixel electrode 191 contact each other is not disposed in, but rather, it is disposed outside the effective display unit, i.e., the four sub-regions Da-Dd, such that texture, where the alignment of the liquid crystal molecules 31 is not controlled, is not generated in any place of the four domains of the liquid crystal layer 3 disposed above the four sub-regions Da-Dd. Accordingly, areas of the effective display regions where the alignment direction of the liquid crystal molecules 31 is uniform are the same as each other in the four domains of the liquid crystal layer 3. Therefore, good lateral visibility may be obtained and the viewing angle is increased regardless of the view direction.

The above may be repeated having a horizontal period 1H such that gate-on voltages Von are sequentially applied to all the gate lines 121 and data voltages are applied to all the pixel electrodes 191 so as to display an image of one frame.

After one frame ends, a subsequent frame begins, and a state of the inversion signal RVS applied to the data driver 500 is controlled so that the polarity of a data voltage applied to each pixel electrode 191 is reversed to be opposite to the polarity of the previous frame, which is referred to as “frame inversion”.

In this case, even in one frame, polarities of data voltages flowing through adjacent data lines may be opposite to each other according to characteristics of the inversion signal RVS (e.g., “column inversion”).

The polarity inversion pattern in the data driver 500 and the polarity inversion pattern represented in the screen of the liquid crystal panel assembly 300 appear to be different according to the connection of the pixel electrodes 191 and the data lines 171.

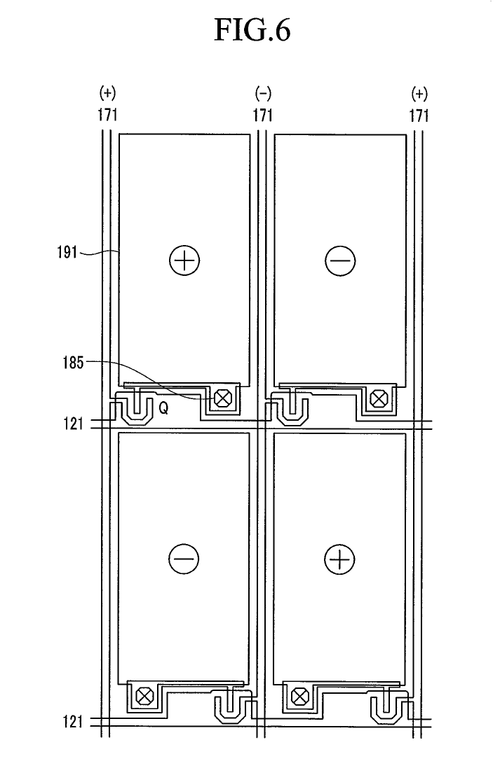

Next, the inversion pattern according to an exemplary embodiment of the present invention will be described with reference to FIG. 6.

FIG. 6 is a view showing the arrangement of pixels and polarities of the data voltages and the pixel voltages in the liquid crystal display according to an exemplary embodiment of the present invention.

Referring to FIG. 6, the neighboring pixel electrodes 191 in a row direction are connected to the data lines 171 disposed in the same direction through the switching element Q, and the neighboring pixel electrodes 191 in a column direction are connected to different data lines 171.

Accordingly, the polarity inversion pattern of data voltages applied to the data lines 171 is a column inversion, whereas the polarity inversion pattern of the pixel voltages is represented as a dot inversion. As a result, the degradation of the display quality due to vertical or horizontal flicker may be prevented.

In this embodiment, the contact hole 185 is disposed in the lower part outside of the four sub-regions Da-Dd such that texture is seldom generated in the liquid crystal layer 3 disposed above the four sub-regions Da-Dd. Accordingly, the viewing angles in various directions can be uniformly increased and the lateral visibility is improved in all directions.

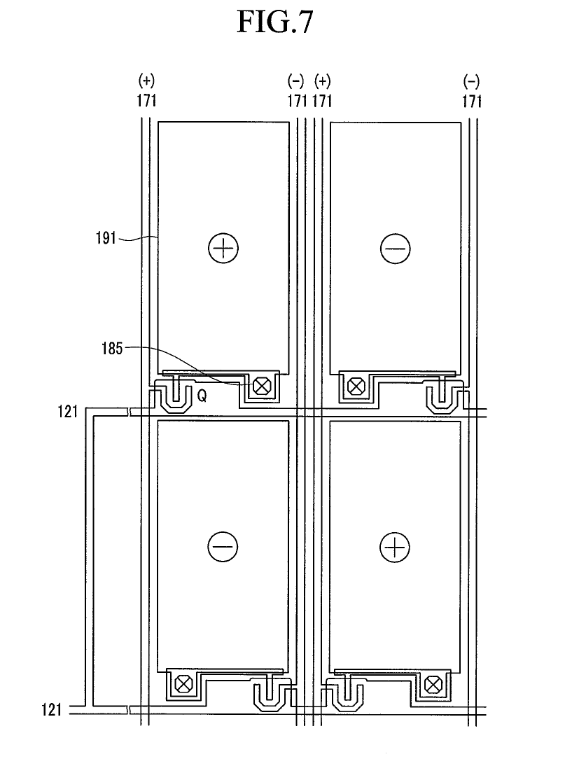

Next, the inversion pattern according to another exemplary embodiment of the present invention will be described with reference to FIG. 7.

FIG. 7 is a view showing the arrangement of pixels and the polarity of data voltages and pixel voltages in the liquid crystal display according to another exemplary embodiment of the present invention.

Referring to FIG. 7, two data lines 171 are disposed between two neighboring pixel electrodes 191 in a row direction. The neighboring pixel electrodes 191 in the row and column directions are connected to the data lines 171 that are disposed on different sides through the switching elements Q.

Also, the two gate lines 121 connected to the pixel electrodes 191 in two neighboring rows are connected to each other at one end thereof such that the same gate signal is simultaneously applied to the pixels PX in the two rows. Accordingly, the charging time of a pixel voltage may be sufficiently obtained and the number of circuits of the gate driver 400 may be reduced.

Also, in the present exemplary embodiment, the polarity inversion pattern of data voltages in the data lines 171 is a column inversion, whereas the polarity inversion pattern of the pixel voltages is a dot inversion, and therefore, the display characteristics of the liquid crystal display may be improved.

Also, as shown in FIG. 6 and FIG. 7, the contact hole 185 is disposed outside of the effective display unit of the pixel electrode 191 including four subregions Da-Dd such that texture is not generated in the liquid crystal layer 3 above the four sub-regions Da-Dd. Accordingly, viewing angles in various directions may be uniformly increased and the lateral visibility in all directions may be improved. In addition, unlike the previously described exemplary embodiments, the width of the gate line 121 disposed below the expansion portion of the drain electrode or the contact hole 185 is narrower than the other portion of the gate line 121.

Unlike the exemplary embodiment shown in FIG. 3 to FIG. 5, a light alignment method where light, such as ultraviolet rays, is obliquely irradiated to the alignment layers 11 and 21 may be used to control the alignment direction and the alignment angle of the liquid crystal molecules 31 as a way for forming a plurality of sub-regions Da-Dd where the liquid crystal molecules 31 are inclined in different directions. In this case, the minute branches 194a-194d of the pixel electrodes 191 are not necessary, and so the aperture ratio may be increased and the response time may be improved by the pre-tilt of the liquid crystal molecules 31 that is generated under the light alignment.

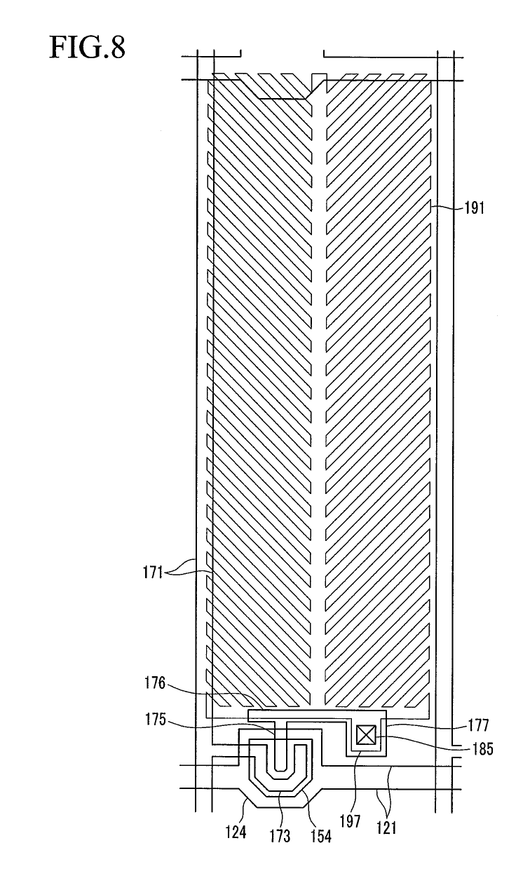

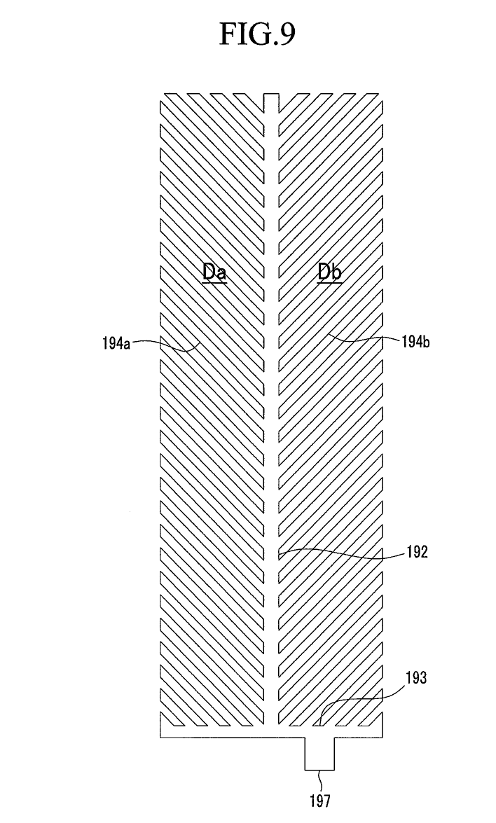

Next, another example of the liquid crystal display shown in FIG. 1 and FIG. 2 will be described with reference to the embodiments of FIG. 8 and FIG. 9.

FIG. 8 is a layout view of a liquid crystal display according to another exemplary embodiment of the present invention, and FIG. 9 is a top plan view of a pixel electrode in the liquid crystal display shown in FIG. 8.

The layered structure of the liquid crystal display according to the present exemplary embodiment is the same as the layered structure of the liquid crystal display shown in the embodiments of FIG. 3 to FIG. 5. Next, the different characteristics from the above described exemplary embodiment will be described.

In the present exemplary embodiment, the pixel electrode 191 includes a transverse stem 193, a longitudinal stem 192, a plurality of first and second minute branches 194a and 194b, and a lower protrusion 197.

The transverse stem 193 forms the lower portion of the pixel electrode 191 and extends in the transverse direction, and the longitudinal stem 192 crosses the transverse stem and extends upward centrally from the transverse stem 193. The pixel electrode 191 is divided into right and left sub-regions Da and Db by the longitudinal stem 192, and the two sub-regions Da and Db form the effective display unit where light is transmitted in the pixel electrode 191.

The first minute branches 194a of the left sub-region Da are obliquely extended from the transverse stem 193 or the longitudinal stem 192 to the left-upper direction. The second minute branches 194b of the right sub-region Db are obliquely extended from the transverse stem 193 or the longitudinal stem 192 to the right-upper direction. The protrusion 197 is connected to the drain electrode 175 through the contact hole 185.

In the present exemplary embodiment, the liquid crystal molecules 31 of the liquid crystal layer 3 disposed on one pixel electrode 191 are inclined in the length directions of the first and second minute branches 194a and 194b such that, in total, two liquid crystal alignment directions are formed.

However, the length direction of the minute branches of the neighboring pixel electrodes 191 in the row or column directions may be changed to make the inclination direction of the liquid crystal molecules 31 diverse, like the previous exemplary embodiment.

Also, like the previous exemplary embodiment, the areas of the effective display region where the alignment direction of the liquid crystal molecules 31 is uniform are the same as each other in the two domains of the liquid crystal layer 3 disposed on the two sub-regions Da and Db such that lateral visibility may be improved in several directions and the viewing angle may be increased.

Unlike the present exemplary embodiment, a light alignment method in which light, such as ultraviolet rays, is obliquely irradiated to the alignment layers 11 and 21 may be used to control the alignment direction and the alignment angle of the liquid crystal molecules 31 as a means for forming a plurality of sub-regions where the liquid crystal molecules 31 are inclined in different directions. In this case, since the minute branches 194a and 194b of the pixel electrodes 191 are not necessary, the aperture ratio may be increased and the response time may be improved owing to the pre-tilt of the liquid crystal molecules 31 that is generated by the light alignment.

The various characteristics and effects of the liquid crystal display shown in FIG. 3 to FIG. 7 may also apply to the liquid crystal display shown in FIG. 8 and FIG. 9.

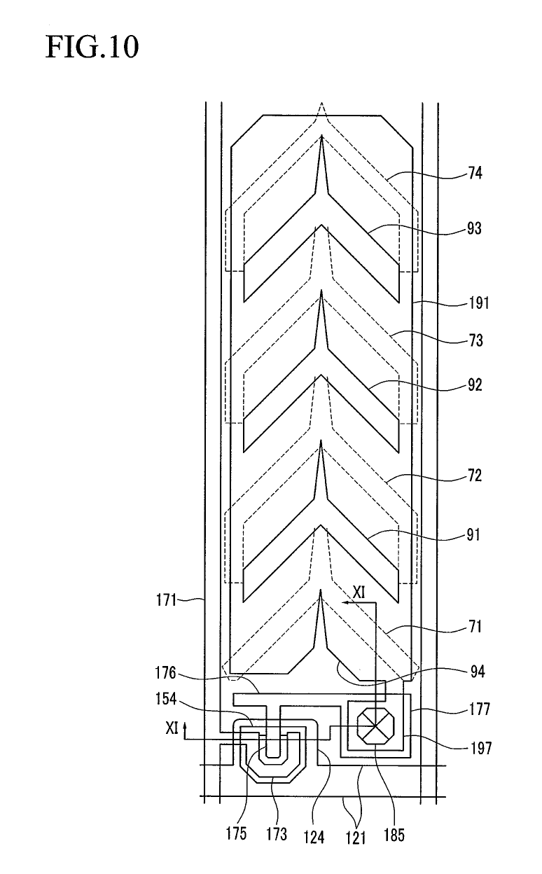

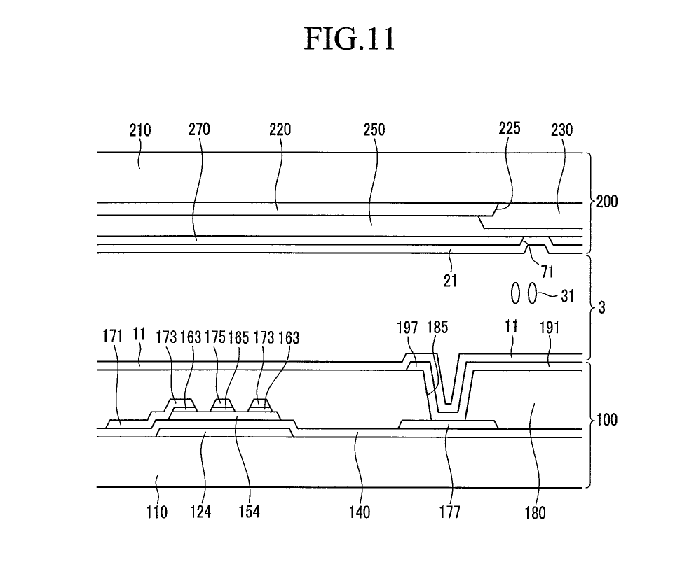

Next, another example of the liquid crystal display shown in FIG. 1 and FIG. 2 will be described with reference to the embodiments of FIG. 10 and FIG. 11.

FIG. 10 is a layout view of a liquid crystal display according to another exemplary embodiment of the present invention, and FIG. 11 is a cross-sectional view of the liquid crystal display shown in FIG. 10 taken along the line XI-XI.

The layered structure of the liquid crystal display according to the present exemplary embodiment is the same as the layered structure of the liquid crystal display shown in the embodiments of FIG. 3 to FIG. 5. Next, characteristics that are different from the exemplary embodiment shown in FIG. 3 to FIG. 5 will be described.

In the present exemplary embodiment, a pixel electrode 191 includes two upper corners chamfered forming two oblique edges, and includes a plurality of cutouts 91, 92, 93 and 94.

The cutout 94 includes an inlet formed at the center of the lower edge of the pixel electrode 191 and a longitudinal cutout portion shortly extending upwards from the inlet. A pair of oblique edges forming the inlet is inclined with respect to the gate lines 121 by an angle of about 45 degrees.

The three cutouts 91-93 are parallel to each other in the longitudinal direction. Each of the cutouts 91-93 includes a pair of right and left oblique portions and a longitudinal cutout portion extending upwards. Each of the right and left oblique portions of the cutouts 91-93 include a pair of oblique edges substantially parallel to the pair of oblique edges forming the inlet of the cutout 94.

The common electrode 270 includes a set of a plurality of cutouts 71, 72, 73 and 74.

The cutouts 71-74 are disposed between the neighboring cutouts 91-94 of the pixel electrode 191 and between the cutout 93 and the chamfered upper oblique edges of the pixel electrode 191.

Each of the cutouts 71-74 includes a pair of oblique portions extending parallel to the oblique portions of the cutouts 91-93 of the pixel electrode 191. Also, each of the three cutouts 72-74 further includes a pair of longitudinal portions extending downwards from the end of the oblique portion while overlapping the edges of the pixel electrode 191 according to the edges of the pixel electrode 191 forming obtuse angles with the oblique portions, and further includes a longitudinal cutout portion extending upwards from the connection point where the pair of oblique portions meet.

At least one of the cutouts 71-74 and 91-94 may be replaced with protrusions or depressions. The protrusions may be made of an organic material or an inorganic material, and may be disposed on or under the electrodes 191 and 270.

The number of the cutouts 71-74 and 91-94 may be changed according to design elements.

In the present exemplary embodiment, the cutouts 71-74 and 91-94 of the pixel electrode 191 and the common electrode 270 along with the chamfered oblique edges of the upper side of the pixel electrode 191, which are parallel to the cutouts 71-74 and 91-94, distort the electric field and form the horizontal component thereof for determining the inclination direction of the liquid crystal molecules. The horizontal component of the electric field is vertical with respect to the edges of the cutouts 71-74 and 91-94 and the chamfered oblique edges of the pixel electrode 191.

As shown in FIG. 10, one cutout set 71-74 and 91-94 divide the pixel electrode 191 into a plurality of sub-regions each having two main edges, and the inclination direction of the liquid crystal molecules in each sub-region is determined by the horizontal component of the electric field. Accordingly, the liquid crystal layer 3 has four domains having different alignment directions of the liquid crystal molecules 31. Meanwhile, the sub-regions of the pixel electrode 191 form an effective display unit where light is transmitted through the pixel electrode 191. In this way, the inclined directions of the liquid crystal molecules 31 are diverse, and thereby the reference viewing angle of the liquid crystal display may be increased.

Also, the switching element Q and contact hole 185 are disposed outside the effective display unit of the pixel electrode 191, that is, outside the plurality of sub-regions, such that texture where the alignment of the liquid crystal molecules is distorted is not generated in any domain of the liquid crystal layer 3 disposed above the plurality of sub-regions. Accordingly, the areas of the effective display regions where the alignment direction of the liquid crystal molecules 31 is uniform are the same as each other in the four domains of the liquid crystal layer 3. Accordingly, good lateral visibility may be obtained and the viewing angle may be increased regardless of the viewing direction.

Many characteristics and effects of the liquid crystal display of the embodiments of FIG. 3 to FIG. 7 may apply to the liquid crystal display shown in the embodiments of FIG. 10 and FIG. 11.

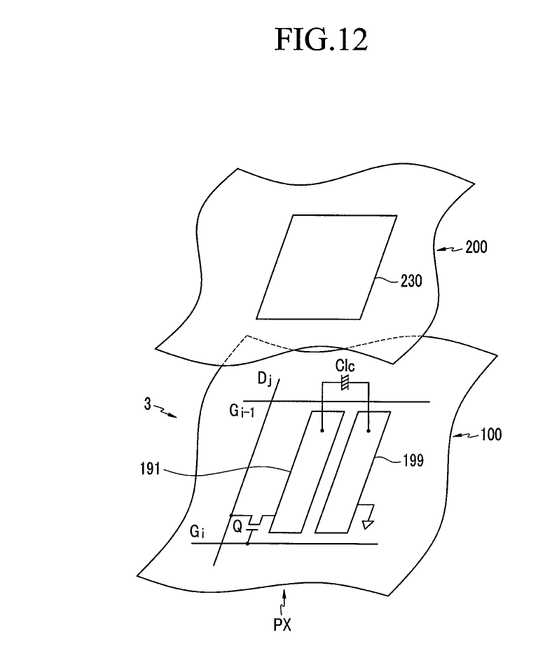

Next, a liquid crystal display according to another exemplary embodiment of the present invention will be described with reference to FIG. 12 to FIG. 14.

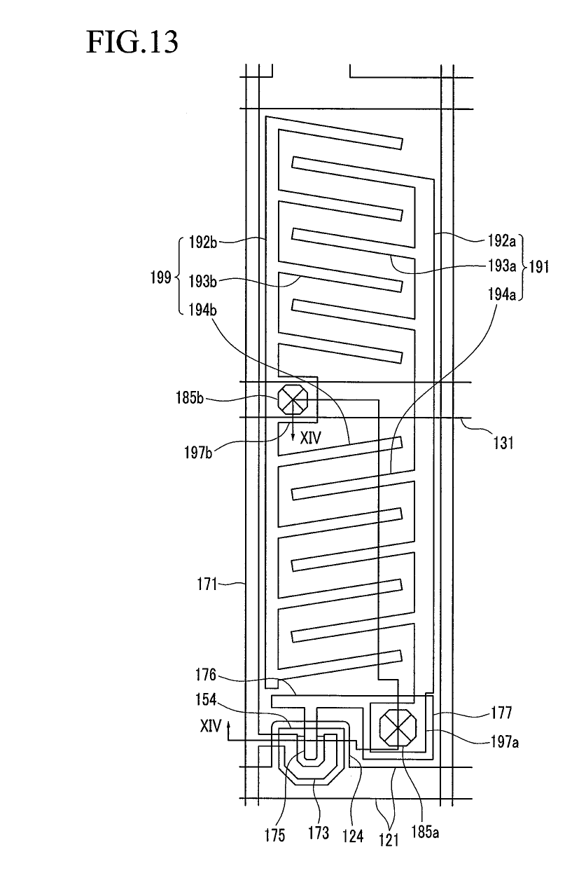

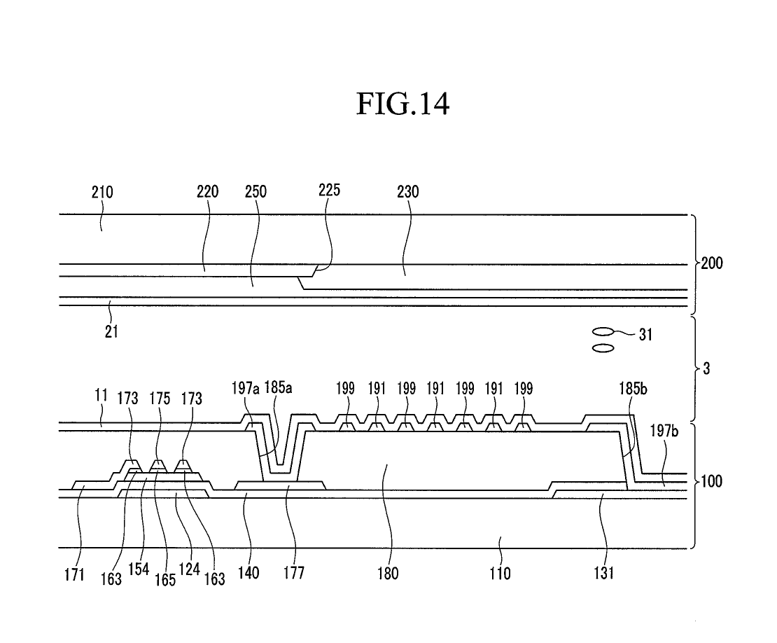

FIG. 12 is an equivalent circuit diagram of one pixel in a liquid crystal display according to another exemplary embodiment of the present invention, FIG. 13 is a layout view of a liquid crystal display according to another exemplary embodiment of the present invention, and FIG. 14 is a cross-sectional view of the liquid crystal display shown in FIG. 13 taken along the line XIV-XIV.

Referring to FIG. 12, in an equivalent circuit view, a liquid crystal display according to the present exemplary embodiment includes a plurality of signal lines including a plurality of gate lines Gᵢ and Gᵢ₋₁, a plurality of data lines Dⱼ, and a plurality of pixels PX that are connected to the signal lines. Meanwhile, in a structural view, the liquid crystal display includes lower and upper display panels 100 and 200 that face each other, and a liquid crystal layer 3 interposed therebetween.

Each pixel PX includes a switching element Q connected to the gate line Gᵢ and the data line Dⱼ, and a liquid crystal capacitor Clc connected thereto.

A control terminal and an input terminal of the switching element Q are respectively connected to the gate line Gᵢ and the data line Dⱼ, and the output terminal thereof is connected to the liquid crystal capacitor Clc.

The liquid crystal capacitor Clc has two terminals, a pixel electrode 191 and a common electrode 199 of the lower panel 100, and the liquid crystal layer 3 on the two electrodes 191 and 199 serves as a dielectric material. The pixel electrode 191 is connected to the switching element Q, and the common electrode 199 is applied with a common voltage Vcom.

A color filter 230 displaying one of the primary colors is provided in a region of the upper panel 200 corresponding to the pixel electrode 191.

Now, one example of the liquid crystal display shown in FIG. 12 will be described with reference to FIG. 13 to FIG. 14.

The layered structure of the liquid crystal display according to the present exemplary embodiment is the same as the layered structure of the liquid crystal display shown in the embodiments of FIG. 3 to FIG. 5.

First, regarding the lower panel 100, a plurality of gate lines 121 including a plurality of gate electrodes 124, and a plurality of common voltage lines 131 are formed on an insulating substrate 110.

The common voltage lines 131 transmit a common voltage and extend in a transverse direction and parallel to the gate lines 121. The common voltage lines 131 are formed in the same layer as the gate lines 121 and may be disposed at the same distance between two neighboring gate lines 121.

A gate insulating layer 140 is formed on the gate lines 121 and the common voltage lines 131. A plurality of semiconductor islands 154, a plurality of ohmic contact islands 163 and 165, a plurality of data lines 171 and a plurality of drain electrodes 175 are sequentially formed on the gate insulating layer 140.

A passivation layer 180 is formed on the data lines 171, the drain electrodes 175, and the exposed semiconductor islands 154.

The passivation layer 180 has a plurality of contact holes 185a exposing the expansions 177 of the drain electrodes 175, and the passivation layer 180 and the gate insulating layer 140 have a plurality of contact holes 185b exposing the common voltage lines 131.

A plurality of pixel electrodes 191 and a plurality of common electrodes 199 are formed in the same layer on the passivation layer 180.

The pixel electrodes 191 include a longitudinal portion 192a extending in a longitudinal direction, an upper branch 193a obliquely extending in the left-up direction from the longitudinal portion 192a, a lower branch 194a obliquely extending in the left-down direction from the longitudinal portion 192a, and a lower protrusion 197a.

Each common electrode 199 includes a longitudinal portion 192b extending in the longitudinal direction, an upper branch 193b obliquely extending in the right-down direction from the longitudinal portion 192b, a lower branch 194b obliquely extending in the right-up direction from the longitudinal portion 192b, and a protrusion 197b protruding in the right direction from the center of the longitudinal portion 192b.

The branches 193a and 194a of the pixel electrode 191, and the branches 193b and 194b of the common electrode 199 face each other and are disposed in turn. The upper branches 193a and 193b are all inclined in the right-down direction to form a first sub-region, and the lower branches 194a and 194b are all inclined in the right-up direction to form a second sub-region. The first sub-region and the second sub-region form an effective display unit where light is transmitted.

An alignment layer 11 is formed on the passivation layer 180, the pixel electrode 191, and the common electrode 199.

Next, regarding the upper panel 200 according to an embodiment, a light blocking member 220 and a plurality of color filters 230 are formed on a substrate 210, and an overcoat 250 and an alignment layer 21 are formed thereon.

The two alignment layers 11 and 21 may be horizontal alignment layers.

The liquid crystal layer 3 interposed between the lower panel 100 and the upper panel 200 includes liquid crystal molecules 31 having positive dielectric anisotropy, and the liquid crystal molecules 31 may be oriented such that the major axes thereof are substantially parallel to the surfaces of the two display panels 100 and 200 when no electric field is applied.

The pixel electrode 191 receives a data voltage from the drain electrode 175 through the contact hole 185a at the protrusion 197a, and the common electrode 199 receives the common voltage Vcom from the common voltage line 131 through the contact hole 185b at the protrusion 197b.

The pixel electrode 191 is supplied with the data voltage, and the common electrode 199 is supplied with the common voltage such that an electric field substantially parallel to the display panels 100 and 200 is generated in the liquid crystal layer 3, and the horizontal component of the electric field is substantially vertical with respect to the branches 193a, 193b, 194a, and 194b of the pixel electrode 191 and the common electrode 199. In response to the electric field, the liquid crystal molecules 31 are rotated for their long axes to be parallel to the electric field. Accordingly, the liquid crystal layer 3 on the first and second sub-regions of the pixel electrode 191 is divided into two domains having different rotation directions of the liquid crystal molecules 31. Therefore, a wide viewing angle may be obtained, and the lateral visibility may be improved as well.

The polarization of light passing through the liquid crystal layer is changed according to the direction of the liquid crystal molecules determined as described above, consequentially changing the light transmittance.

The pixel electrode 191 and the common electrode 199 form a liquid crystal capacitor Clc including the liquid crystal layer 3 as a dielectric material to maintain the supplied voltages even after the thin film transistor Q is turned off.

Many characteristics and effects of the liquid crystal display shown in the embodiments of FIG. 3 to FIG. 7 may apply to the liquid crystal display shown in the embodiments of FIG. 12 to FIG. 14.

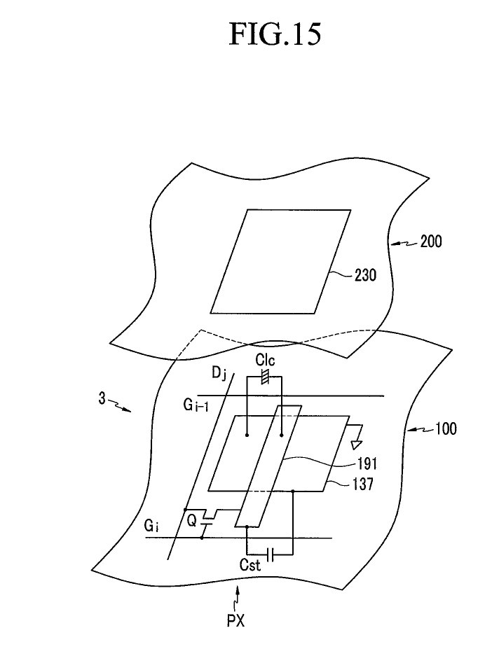

Finally, a liquid crystal display according to another exemplary embodiment of the present invention will be described with reference to FIG. 15 to FIG. 17.

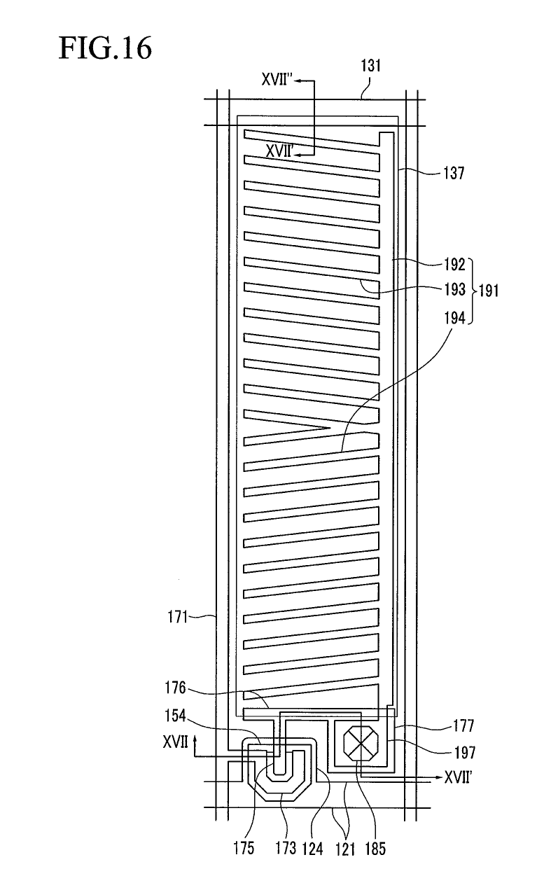

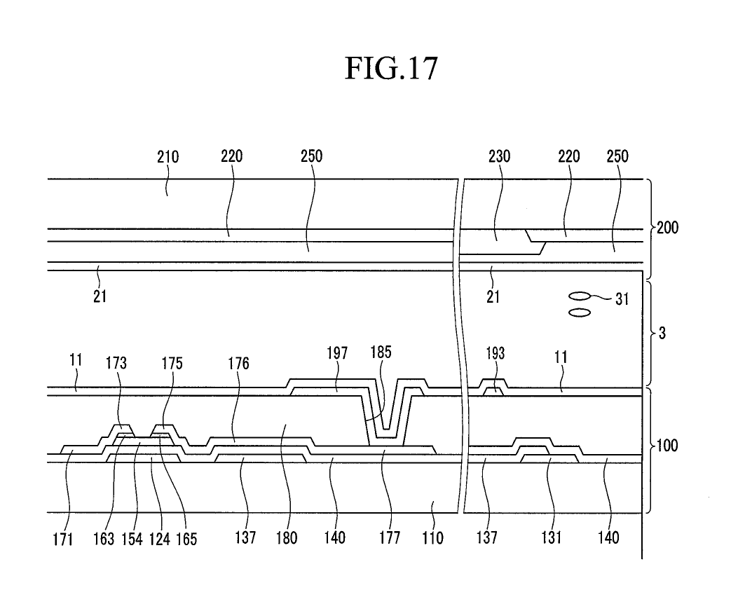

FIG. 15 is an equivalent circuit diagram of one pixel in a liquid crystal display according to another exemplary embodiment of the present invention, FIG. 16 is a layout view of a liquid crystal display according to another exemplary embodiment of the present invention, and FIG. 17 is a cross-sectional view of the liquid crystal display shown in FIG. 16 taken along the line XVII-XVII.

Referring to FIG. 15, in an equivalent circuit view, a liquid crystal display according to the present exemplary embodiment includes a plurality of signal lines including a plurality of gate lines Gᵢ and G₍ᵢ₋₁₎, a plurality of data lines Dⱼ, and a plurality of pixels PX that are connected to the signal lines. Meanwhile, in a structural view, the liquid crystal display includes lower and upper display panels 100 and 200 that face each other and a liquid crystal layer 3 interposed therebetween.

Each pixel PX includes a switching element Q connected to the gate line Gᵢ and the data line Dⱼ, and a liquid crystal capacitor Clc and a storage capacitor Cst connected thereto.

A control terminal and an input terminal of the switching element Q are respectively connected to the gate line Gᵢ and the data line Dⱼ, and an output terminal thereof is connected to the liquid crystal capacitor Clc and the storage capacitor Cst.

The liquid crystal capacitor Clc has two terminals, a pixel electrode 191 and a common electrode 137 of the lower panel 100. The liquid crystal layer 3 above the two electrodes 191 and 137 serves as a dielectric material. The pixel electrode 191 is connected to the switching element Q, and the common electrode 137 is supplied with a common voltage Vcom.

The storage capacitor Cst, which serves as an auxiliary to the liquid crystal capacitor Clc, is formed as the common electrode 137 and the pixel electrode 191, which are provided on the lower panel 100, overlap each other with an insulator interposed therebetween.

A color filter 230 displaying one of the primary colors is provided in a region of the upper panel 200 corresponding to the pixel electrode 191.

Now, one example of the liquid crystal display shown in FIG. 15 will be described with reference to FIG. 16 and FIG. 17.

The layered structure of the liquid crystal display according to the present exemplary embodiment is the same as the layered structure of the liquid crystal display shown in the embodiments of FIG. 3 to FIG. 5.

First, regarding the lower panel 100, a plurality of gate lines 121 including a plurality of gate electrodes 124, and a plurality of common voltage lines 131 are formed on an insulating substrate 110.

The common voltage lines 131 transmit a common voltage and extend in a transverse direction and parallel to the gate lines 121. The common voltage lines 131 are formed in the same layer as the gate lines 121 and are disposed between two neighboring gate lines 121.

A plurality of common electrodes 137 are formed on the substrate 110 and the common voltage lines 131. The common electrodes 137 may have a rectangular shape, and are disposed in a matrix almost filling the space between the gate lines 121. The common electrodes 137 are connected to the common voltage lines 131 and receive the common voltage.

The common electrodes 137 may be made of a transparent material such as ITO or IZO.

A gate insulating layer 140 is formed on the gate lines 121, the common voltage lines 131, and the common electrodes 137. The gate insulating layer 140 prevents the gate lines 121 and the common electrodes 137 from short-circuiting, and insulates them from other conductive layers that may be subsequently applied.

A plurality of semiconductor islands 154, a plurality of ohmic contact islands 163 and 165, a plurality of data lines 171, a plurality of drain electrodes 175, and a passivation layer 180 may be sequentially formed on the gate insulating layer 140.

A plurality of pixel electrodes 191 having a comb shape is formed on the passivation layer 180. Each of the pixel electrodes 191 overlaps the common electrode 137 and includes a plurality of upper and lower branches 193 and 194 and a connection 192 for connecting them.

The connection 192 extends in a longitudinal direction according to the right edge of the common electrode 137. The upper branches 193 obliquely extend in the left-up direction from the connection 192, and the lower branches 194 obliquely extend in the left-down direction from the connection 192.

Each of the pixel electrodes 191 is divided into two sub-regions by the branches 193 and 194 having different directions, and the two sub-regions form an effective display unit where light is transmitted.

An alignment layer 11 is formed on the passivation layer 180 and the pixel electrodes 191.

Next, regarding the upper panel 200, a light blocking member 220, and a plurality of color filters 230 may be formed on the substrate 210, and an overcoat 250 and an alignment layer 21 may also be formed thereon.

The two alignment layers 11 and 21 may be horizontal alignment layers.

The liquid crystal layer 3 interposed between the lower panel 100 and the upper panel 200 includes liquid crystal molecules 31 having positive dielectric anisotropy, and the liquid crystal molecules 31 may be oriented such that the major axes thereof are substantially parallel to the surfaces of the two display panels 100 and 200 when no electric field is applied.

The pixel electrode 191 is supplied with a data voltage, and the common electrode 137 is supplied with the common voltage such that an electric field substantially parallel to the display panels 100 and 200 is generated in the liquid crystal layer 3, and the horizontal component of the electric field is substantially vertical with respect to the branches 193 and 194 of the pixel electrode 191. In response to the electric field, the liquid crystal molecules 31 are rotated for their long axes to be parallel to the electric field. Accordingly, the liquid crystal layer 3 on the first and second sub-regions of the pixel electrodes 191 is divided into two domains having different rotation directions of the liquid crystal molecules 31. Therefore, a wide viewing angle may be obtained and the lateral visibility may be improved.

The pixel electrode 191 and the common electrode 137 form a liquid crystal capacitor Clc including the liquid crystal layer 3 as a dielectric material to maintain the supplied voltage even after the thin film transistor Q is turned off. The two electrodes 191 and 137 also form a storage capacitor Cst with the gate insulating layer 140 and the passivation layer 180 as a dielectric material such that the voltage maintaining capacity of the liquid crystal capacitor Clc is enhanced.

Also, in the present exemplary embodiment, the switching element Q and contact hole 185 are disposed outside the effective display unit of the pixel electrode 191, that is, outside the two sub-regions, such that texture where alignment of the liquid crystal molecules is distorted is not generated in any domain of the liquid crystal layer 3 disposed on the two sub-regions. Accordingly, the areas of effective display regions where the alignment direction of the liquid crystal molecules 31 is uniform are the same in the two domains of the liquid crystal layer 3. Accordingly, good lateral visibility may be obtained and the viewing angle is increased regardless of the viewing direction.

Many characteristics and effects of the liquid crystal display of the embodiments of FIG. 3 to FIG. 7 may apply to the liquid crystal display shown in the embodiments of FIG. 15 and FIG. 17.

Alternatively in the exemplary embodiment shown in FIG. 12 to FIG. 17, the liquid crystal molecules 31 may have negative dielectric anisotropy. Then, the liquid crystal molecules 31 are inclined vertically with respect to the electric field generated in the liquid crystal layer 3.

According to an exemplary embodiment of the present invention, alignment directions of the liquid crystal molecules in the liquid crystal layer disposed at one pixel of a liquid crystal display may be diverse, and texture, where the orientation of the liquid crystal molecules is not regulated, is not generated in each domain of the liquid crystal layer having different alignment directions of the liquid crystal molecules such that the areas of the effective display regions of the respective domains may be the same as each other among the domains. Accordingly, good lateral visibility may be obtained regardless of the viewing direction, a transverse line spot is not generated, and the viewing angle is increased.

Also, the influence on the pixel voltage by the gate signal may be reduced thereby improving the display characteristics.

While practical exemplary embodiments have been described, it is to be understood that the disclosure is not limited to the disclosed embodiments, but, on the contrary, is intended to cover various modifications and equivalent arrangements included within the spirit and scope of the appended claims.

What is claimed is:

1. A liquid crystal display comprising:
a first substrate and a second substrate;
a plurality of pixel electrodes formed on the first substrate and arranged in a matrix;
a common electrode facing the pixel electrodes; and
a liquid crystal layer interposed between the first substrate and the second substrate and including a plurality of liquid crystal molecules,
wherein the liquid crystal layer includes a plurality of domains having different alignment directions of the liquid crystal molecules, and
areas of an effective display region where the alignment direction of the liquid crystal molecules is uniform in each domain are the same among the plurality of domains.

2. The liquid crystal display of claim 1, further comprising:
a plurality of gate lines formed on the first substrate;
a plurality of data lines intersecting the gate lines and transmitting data signals; and
a plurality of switching elements each including a gate electrode connected to a respective gate line, a source electrode connected to a respective data line, and a drain electrode connected to a respective pixel electrode.

3. The liquid crystal display of claim 2, wherein:
the switching element is disposed in a region overlapping a lower portion of the pixel electrode and close to the data line.

4. The liquid crystal display of claim 3, wherein
the drain electrode includes:
an expansion portion contacting a portion of the pixel electrode and transmitting data signals;
a bar portion facing the source electrode; and
a transverse portion connecting the bar portion and the expansion portion in a horizontal direction,
wherein the expansion portion is disposed in a region overlapping a lower portion of the pixel electrode and beside the switching element.

5. The liquid crystal display of claim 4, wherein:
a width of the gate line disposed below the expansion portion of the drain electrode is narrower than the other portion of the gate line.

6. The liquid crystal display of claim 4, wherein:
a portion of the transverse portion of the drain electrode overlaps a lower end portion of the pixel electrode.

7. The liquid crystal display of claim 4, wherein:
the transverse portion of the drain electrode is formed in the transverse direction following a lower edge of the pixel electrode.

8. The liquid crystal display of claim 7, wherein:
a length of the transverse portion of the drain electrode is more than half of a length of the lower edge of the pixel electrode.

9. The liquid crystal display of claim 4, wherein:
a width of the transverse portion of the drain electrode is less than a cell gap of the liquid crystal layer.

10. The liquid crystal display of claim 2, wherein:
polarities of the data signals applied to two neighboring pixel electrodes in a row direction or a column direction are opposite to each other.

11. The liquid crystal display of claim 10, wherein:
polarities of the data signals applied to two neighboring data lines are opposite to each other.

12. The liquid crystal display of claim 11, wherein:
one data line is disposed between two neighboring columns of the pixel electrodes, and
two neighboring switching elements in a row direction or a column direction are connected to different data lines that are adjacent to each other.

13. The liquid crystal display of claim 11, wherein:
two data lines are disposed between the neighboring columns of the pixel electrodes,
two neighboring switching elements in a column direction are connected to different data lines that are adjacent to each other, and
two neighboring switching elements in a row direction are connected to different data lines that are not adjacent to each other.

14. The liquid crystal display of claim 13, wherein:
a pair of gate lines connected to the pixel electrodes of two neighboring rows transmit the same gate signal.

15. The liquid crystal display of claim 2, wherein:
the common electrode is formed on the second substrate.

16. The liquid crystal display of claim 15, further comprising:
an inclination direction determination member formed in the pixel electrode or the common electrode.

17. The liquid crystal display of claim 16, wherein:
the inclination direction determination member includes cutouts or protrusions.

18. The liquid crystal display of claim 15, wherein
the pixel electrode includes a plurality of minute branches, and
the pixel electrode includes a plurality of sub-regions having different length directions of the minute branches.

19. The liquid crystal display of claim 2, wherein
the common electrode is formed on the first substrate.

20. The liquid crystal display of claim 19, wherein:
the pixel electrode and the common electrode are formed in the same layer;
the common electrode includes a plurality of branches and a longitudinal portion connecting the branches to each other;
the pixel electrode includes a plurality of pixel branches and a longitudinal pixel portion connecting the pixel branches to each other;
the branches and the pixel branches are inclined forming an oblique angle with the gate lines; and
the branches and the pixel branches are alternately disposed.

21. The liquid crystal display of claim 19, wherein
the common electrode is formed under the pixel electrode, and
the pixel electrode includes a plurality of pixel branches.

22. The liquid crystal display of claim 21, wherein:
the pixel branches are inclined forming an oblique angle with the gate lines.

23. A liquid crystal display comprising:
a first substrate and a second substrate;
a gate line formed on the first substrate;
a data line intersecting the gate line and transmitting a data signal;
a switching element including a gate electrode connected to the gate line, a source electrode connected to the data line, and a drain electrode;
a pixel electrode including a contact portion overlapping and connected to an end portion of the drain electrode, and an effective display unit; and
a liquid crystal layer interposed between the first substrate and the second substrate and including a plurality of liquid crystal molecules,
wherein the effective display unit of the pixel electrode includes a plurality of sub-regions, and alignment directions of the liquid crystal molecules disposed above the plurality of sub-regions are different from each other, and
the switching element and the contact portion are disposed outside the effective display unit.
